(19) United States
(12) Patent Application Publication
(10) Pub. No.: US 2013/0181845 A1
(43) Pub. Date: Jul. 18, 2013

(54) AMI NETWORK WITH WORKFORCE MANAGEMENT HOTSPOT ACCESS

(71) Applicant: Matthew Johnson, Spokane, WA (US)

(72) Inventor: Matthew Johnson, Spokane, WA (US)

(73) Assignee: ITRON, INC., Liberty Lake, WA (US)

(21) Appl. No.: 13/350,222

(22) Filed: Jan. 13, 2012

(51) Int. Cl. H04W 84/12; G08C 15/06

(52) U.S. Cl. 340/870.02; 370/338

(57) ABSTRACT

Disclosed are apparatus and methodology for providing communications functionality between a utility central facility and a field worker. A WiFi Hotpoint is associated with a cell relay in an Advanced Metering System (AMS). Field workers using WiFi enabled communications devices may securely receive information including work orders from the utility central facility via the WiFi connection, thereby reducing or eliminating need for the worker to visit the utility central facility.

### FIELD OF THE SUBJECT MATTER

The presently disclosed subject matter relates to advanced metering infrastructure (AMI) networks and, more specifically, to the provision of worker access to remote utility systems within such networks.

### BACKGROUND OF THE SUBJECT MATTER

It is an unfortunate fact that almost every system or device will experience some failure over its lifetime. In the utility industry, for example in advanced metering infrastructure (AMI), such failures may be associated with diverse types of equipment including such as consumption measuring equipment including electricity, water, and/or gas meters that may be installed over large areas. Other failures may vary depending upon weather and other conditions including downed power lines, broken delivery lines or pipes, and other equipment outages.

In many instances, utility workers need to drive to such as a utility company yard or office to download work orders before beginning their work for the day. Such time and travel costs reduce the productivity of the field workers and add to the utility company's costs thorough increased wear and tear on company vehicles as well as increased fuel costs. In view of such known concerns, it would be advantageous to provide mechanisms to address such cost and productivity issues.

While various implementations of AMI networks have been developed, and while various combinations of network features have been provided, no design has emerged that generally encompasses all of the desired characteristics as hereafter presented in accordance with the presently disclosed subject technology.

### SUMMARY OF THE SUBJECT MATTER

In view of the recognized features encountered in the prior art and addressed by the presently disclosed subject matter, improved apparatus and methodology for providing remote access to utility company central facility management resources have been provided.

The presently disclosed subject matter relates in general to a network comprising a cell relay, a central facility including a management system, and a local area network coupling the cell relay and the central facility. In such network, the cell relay may include such as WiFi functionality configured to provide communications with at least the central facility. In order to enable a utility worker to receive information from the central facility, the worker is provided with a WiFi enabled communications device (i.e., devices capable of wireless communications with a network and/or access point using IEEE 802.11 family of standards). The communications device enables a utility worker to receive and respond to work order information from the central facility (via the cell relay). In selected embodiments, the local area network may be connected to a wide area network that in specific embodiments is the Internet. A firewall optionally may be coupled between the cell relay and the local area network.

In particular embodiments of the presently disclosed subject matter, the WiFi enabled communications device may comprise one of a laptop computer, a netbook computer, a tablet computer, a personal digital assistant (PDA), a cell phone, a smart phone, a desktop computer, and a dedicated wireless communication device that may be configured to provide bi-directional WiFi communications functionality. In some embodiments of the presently disclosed subject matter, at least one utility consumption measuring meter configured to measure consumption and store consumption related data may be provided along with a collection engine associated with the central facility. In such manner, the at least one utility consumption measuring meter may be configured to send its stored consumption related data to the collection engine by way of the cell relay.

The presently disclosed subject matter also relates to a cell relay. In such embodiments, the cell relay may include a first communications channel for communicating utility consumption related data to a central facility and a WiFi enabled communications channel for communicating information from a central facility to a field worker proximate the cell relay. In selected such embodiments, the WiFi enabled communications channel may employ an Internet Protocol (IP) communications standard, and, in other embodiments, may be configured to enable bi-directional communications between the cell relay and a central facility.

The presently disclosed subject matter also equally relates to corresponding and/or related methodologies for providing communications capabilities between a network central facility and a remote field worker. According to various of such methods, a network including network components corresponding to a central facility, a cell relay, and at least one consumption measuring device may be established. Such exemplary methodology further calls for establishing a first communications channel to provide communications among the network components and establishing a second, wireless communications channel for the cell relay. Such exemplary methodology may otherwise also involve configuring of the second communications channel to provide communications between the central facility and a worker proximate the cell relay.

In selected embodiments of the presently disclosed methodology, establishing a second communications channel may comprise establishing a WiFi communications channel.

In particular embodiments of exemplary presently disclosed methodology, the second, wireless communications channel may be configured to provide communications between the cell relay and a worker proximate the cell relay. Further, the first communications channel in such instances may be configured to carry information from the second communications channel between the cell relay and the central facility.

In some embodiments of presently disclosed methodology, the central facility may include work order generating functionality and the second communications channel may transmit work order information to a worker proximate the cell relay.

Additional embodiments of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments and uses of the subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the presently disclosed subject matter, including the best mode thereof, directed to one of ordinary skill in the art, is set forth in the specification, which makes reference to the appended figures, in which:

FIG. 1 represents an exemplary communications system constructed in accordance with the presently disclosed subject matter;

FIG. 2 represents an exemplary embodiment of an Advanced Metering System (AMS) deployment such as for use in conjunction with the presently disclosed subject matter; and

FIG. 3 illustrates a flow chart illustrating exemplary communications methodologies in accordance with the presently disclosed subject matter.

Repeat use of reference characters throughout the present specification and appended drawings is intended to represent same or analogous features, elements, or steps.

### DETAILED DESCRIPTION OF THE SUBJECT MATTER

As discussed in the Summary of the Subject Matter section, the presently disclosed subject matter is particularly concerned with systems and methodologies for providing utility workers access to work order systems and/or instructions at, for example, a utility central facility.

Selected combinations of aspects of the disclosed technology correspond to a plurality of different embodiments of the presently disclosed subject matter. It should be noted that each of the exemplary embodiments presented and discussed herein should not insinuate limitations of the presently disclosed subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

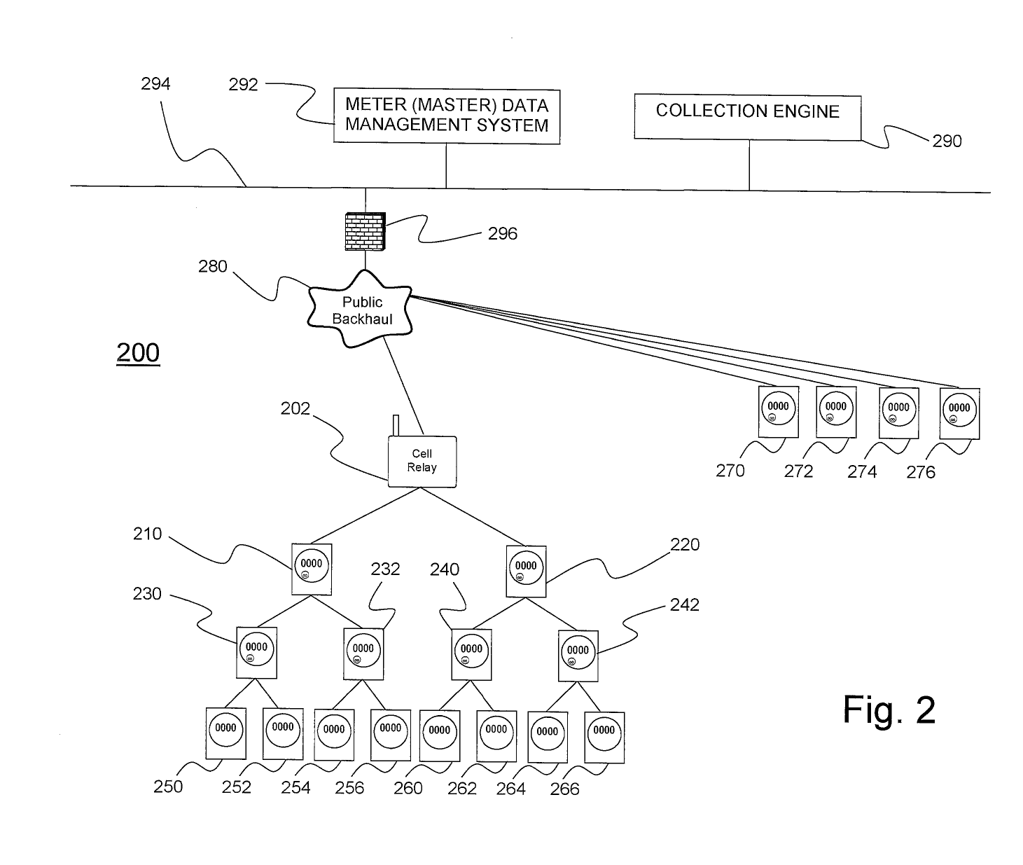

With initial reference to FIG. 2, it will be seen that an exemplary Advanced Metering System (AMS) or Advanced Metering Infrastructure (AMI) generally 200 deployment is represented. FIG. 2 illustrates for exemplary purposes only a single RF LAN cell, with multiple member nodes organized into three levels, as well as four directly connected IP meters 270, 272, 274, and 276. In such representative system, respective meter devices 210, 220, 230, 232, 240, 242, 250, 252, 254, 256, 260, 262, 264, 266, 270, 272, 274, and 276, Cell Relay 202, and Collection Engine 290, have C12.22 network addresses. Collection Engine 290 may have multiple C12.22 addresses to allow for separate addressing between different services (functionalities). Meter (or master) data management system 292 communicates over the Utility LAN 294 to Collection Engine 290 via Web Services. Communications between Cell Relay 202 and Utility LAN 294 variously involve Public Backhaul 280 and firewall 296, as well understood by those of ordinary skill in the art. See also, publicly available disclosure such as commonly owned United States Patent Application Publication No. 2008/0068214 A1, the disclosure of which is for all purposes fully incorporated herein by reference thereto.

The meter data acquisition process may begin, for example, with the Meter (or Master) Data Management System 292 initiating a request for data. Such operation may be done through a web services call to Collection Engine 290 and may be performed without knowledge of the configured functionality of the end-device. Broadcast and/or multicast messages may be sent by Cell Relay 202 to all members of the cell, either via an AMS RF LAN-level broadcast, or by the Cell Relay 202 repeating the message.

In at least some instances, such requests may be sent as a call to a manufacturer's stored procedure. Such a stored procedure may, for example, send a default upload configured for such device. For example, a given meter may be configured to upload two channels of hourly interval data, plus its event history. Another meter, for example, might be programmed to send up data from its Time of Use (TOU) registers. The stored procedure will typically require four parameters to be fully operative in accordance with the presently disclosed subject matter: data start time, data end time, response start time, and response end time. The data start and end times are generally used per the present example to select which data to send. The response start time and end time are used to determine the window within which the upstream system wants to receive the data. The various AMS enabled meters of FIG. 2 are preferably field programmable as to the type data to be included in a default upload.

In accordance with presently disclosed technology, several of the groupings of meters illustrated in FIG. 2 may correspond to various types of meters at or near a residence or customer premises that may take advantage of the AMS communication system of the presently disclosed subject matter to form a home area network. For example, in particular, meters 230, 232, 240, and 242 may correspond to electricity meters in a meter group; meters 250, 254, 260, and 264 may correspond to water meters associated with meters 230, 232, 240, and 242, respectively, and meters 252, 256, 262, and 266 may correspond to gas meters associated with meters 230, 232, 240, and 242 respectively.

According to presently disclosed technology, representative electricity meters 230, 232, 240, and 242 may include communications equipment that is constantly energized by way of the individual meters connection to a source of power, such as a source of alternating current (AC) electricity. Representative meters 250, 252, 254, 256, 260, 262, 264, and 266, on the other hand, generally if not electricity meters, are not coupled to an AC source but rather their communications equipment may be supplied by way of an onboard battery power supply or other alternative arrangements (details of which form no particular part of the presently disclosed subject matter). In such manner, electricity meters 230, 232, 240, and 242 form hubs for a home area network through which representative “non-electricity” meters 250, 252, 254, 256, 260, 262, 264, and 266 may communicate with Collection Engine 290 or other network nodes. Such other network nodes may include other types of devices residing within a residence or customer premises including devices such as, but not limited to, appliances, display devices, and electronic control devices.

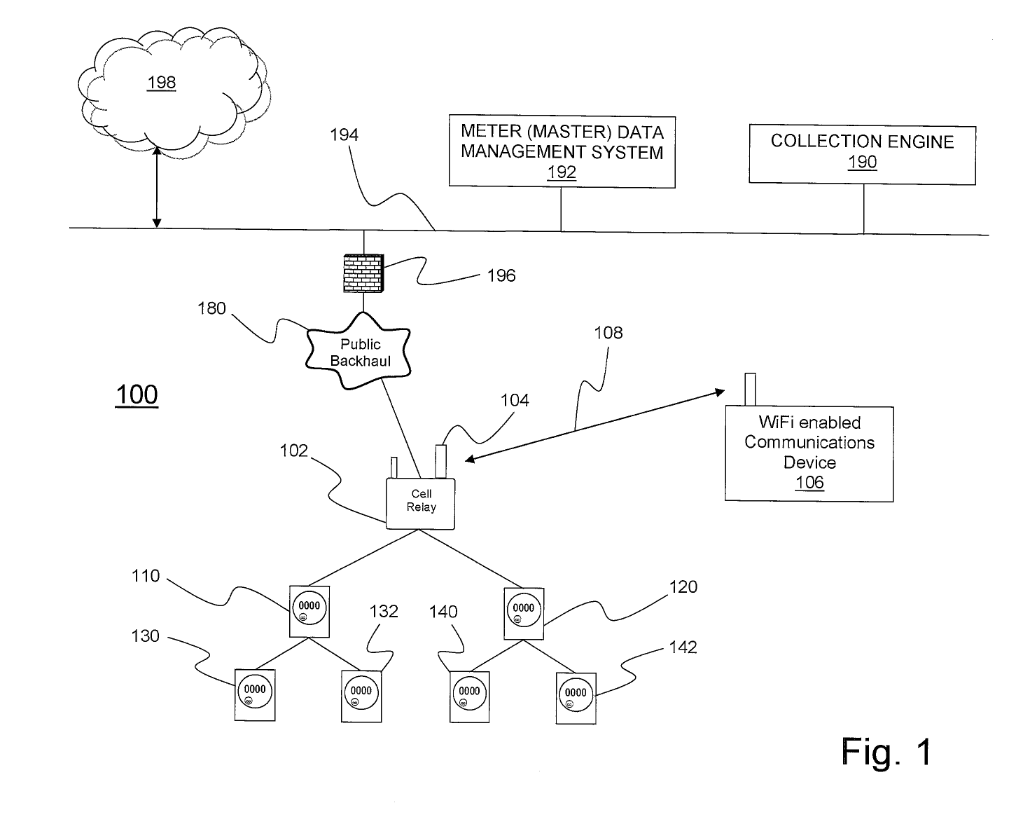

With reference to FIG. 1, there is illustrated an exemplary or representative communications system 100 constructed in accordance with the presently disclosed subject matter. It should be appreciated that various of the illustrated components of FIG. 1 may be in some instances identical to their corresponding components in FIG. 2. For instance, meters 110, 120, 130, 132, 140, 142 in the illustrated example correspond exactly to meters 210, 220, 230, 232, 240, 242, respectively, from FIG. 2 and provide all the same general functionality and features already described with the FIG. 2 counterparts. Similarly, Public Backhaul 180, Collection Engine 190, Meter (or Master) Data Management System 192, Utility LAN 194, and firewall 196 may correspond exactly in make-up and/or functionality to their 200 series counterparts from FIG. 2. Consequently, such components do not require further detailed description in order to be well understood by one of ordinary skill in the art from the disclosure herewith.

Those of ordinary skill in the art will also appreciate from the complete disclosure herewith that meters similar to representative meters 250, 252, 254, 256, 260, 262, 264, 266 of FIG. 2 may also be present in the system 100 embodiment.

On the other hand, and in accordance with the presently disclosed subject matter, Cell Relay 102 preferably differs from representative Cell Relay 202 (also recognized as a Cell Control Unit (CCU)) by the inclusion of a WiFi access port as represented by antenna 104. With the provision of such WiFi access port, utility workers, in accordance with the presently disclosed subject matter, are provided with a WiFi Hotspot through which they may gain easy access to a utility's work order system associated with, for example, Meter (or Master) Data Management System 192. Such presently disclosed WiFi access port provides a second communications channel for the Cell Relay 102 while its first channel may be used per presently disclosed subject matter to relay utility data between, for example, meters 110, 120, 130, 132, 140, 142, and the central facility, including, for example, collection engine 190 and Meter (or Master) Data Management System 192.

In an exemplary embodiment, a utility worker may employ any WiFi enabled communications device 106 to establish a representative bi-directional connection 108 via a WiFi access port associated with Cell Relay 102 through antenna 104 to gain information from a work order functionality or other data at the utility's central location. In addition, the field worker may also be permitted to gain access to the World Wide Web (WWW), Internet, cloud, or other wide area network (WAN) representatively illustrated by WAN 198 by way of bi-directional Internet Protocol (IP) connection 108 and coupling of WAN 198 to Utility LAN 194.

Those of ordinary skill in the art will appreciate that while the presently disclosed subject matter is also in some instances directed more specifically to the use of a WiFi communications channel associated with Cell Relay 102 and corresponding WiFi enabled communications devices, such is exemplary only. In fact, any alternative wireless communications channel (using either of a presently known or a future developed wireless technology) may be established as the communications channel to provide access to, and information exchange functionality between, the utility central facility functionalities and devices of proximate field workers via, for example, Cell Relays remote from the central facility.

Certain embodiments of the presently disclosed subject matter may provide WiFi access for utility employees to work order and other systems at the utility central facility by making an IP connection through a WiFi port associated with Cell Relay 102, also sometimes identified as a Cell Control Unit (CCU). A secure, authenticated connection may be provided to transmit work order and other information to and from the utility worker's WiFi enabled communications device 108 and across the AMI backhaul 180 to the utility's central office. Those of ordinary skill in the art will appreciate that the utility worker's WiFi enabled communications device 108 may, without limitation, correspond to such as a laptop computer, PDA, tablet computer, dedicated communications device, or any other now existing or later developed device capable of WiFi communication. Such WiFi enabled communications device generally 106 may include any combination of display screen, keyboard (or touch screen), processor, memory, or other such components as may be required or desired to exchange information, including, but not limited to, work orders, between a field worker and a central facility.

By associating a WiFi Hotspot functionality (represented by antenna 104) with Cell Relay 102 and employing a WiFi enable communications device 106, utility workers across the utility territory will generally always be only a short drive from a location where they may have an ability to download work orders as well as other types of information at the beginning of their shifts without the need to drive to a utility facility, or the ability to communicate back. Such a practice would not only reduce vehicle operating and maintenance (O&M) expenses but also improve worker productivity.

In addition, the provision of such WiFi Hotspot functionality in Cell Relay 102, especially when a private backhaul 180 is used in the AMI network, further leverages the backhaul network, providing greater return on the investment of deploying any such network. For example, provision of such functionality provides the customer with increased operation value when deploying an AMI network by reducing the costs associated with workforce communications and dispatch. The presently disclosed subject matter generally relates to use with either of fixed networks or open standards collectors.

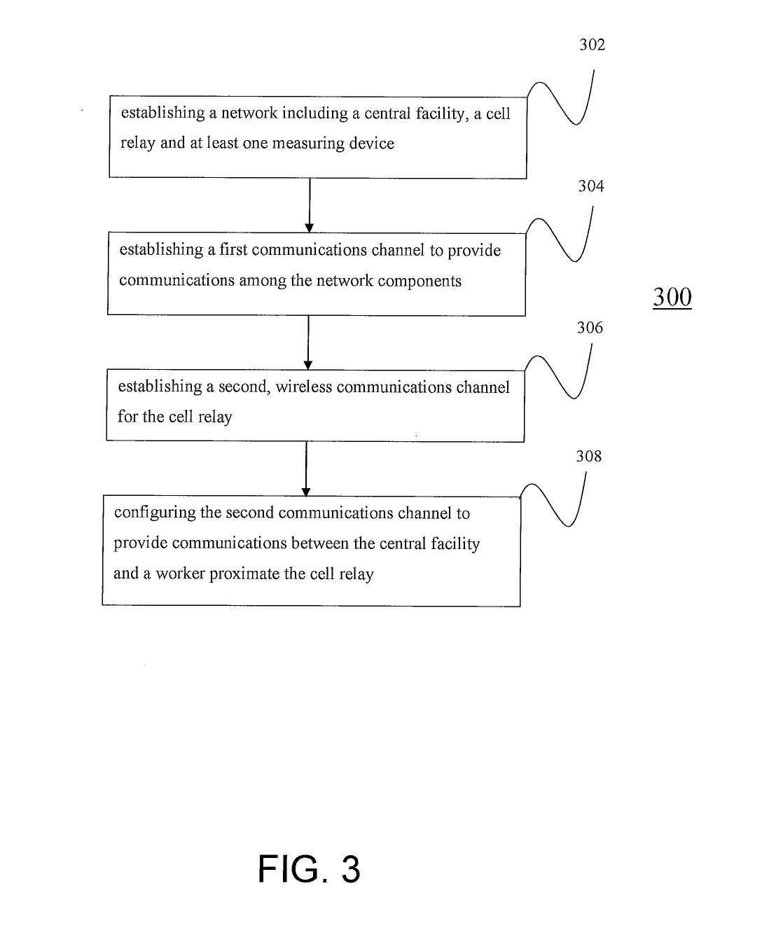

With reference to presently disclosed FIG. 3, there is illustrated a flow chart generally 300 illustrating exemplary communications methodologies in accordance with the presently disclosed subject matter. In accordance with the presently disclosed subject matter, methodology for providing communications capabilities between a network central facility and a remote field worker has been provided. Exemplary such methodology may involve establishing a network including network components corresponding to a central facility, a cell relay, and at least one consumption measuring device (step 302). As a part of such exemplary methodology, a first communications channel may be established to provide communications among the network components (step 304). As will be appreciated by those of ordinary skill in the art, such first communications channel may be in whole or in part established using wireless technologies. Depending on the various types of meters provided, some meters may be interconnected via wired connection to other types of meters that then collect and transmit data to an associated central facility. For example, a water and/or gas meter might be connected by wired connection to an electricity meter that could be configured to send up not only its own data but also data from such associated water and gas meters.

Exemplary methodology in accordance with the presently disclosed subject matter then may call for establishing a second, wireless communications channel for the cell relay (step 306), and configuring the second communications channel to provide communications between the central facility and a worker proximate the cell relay (step 308). In selected embodiments, such second wireless communications channel may be established by associating a WiFi transceiver with the Cell Relay 102 (see also present FIG. 1).

In particular embodiments of the presently disclosed subject matter, present methodology may also provide for configuring the wireless channel to provide communications between the cell relay and a worker proximate the cell relay, and configuring the first communications channel to carry information from the second communications channel between the cell relay and the central facility. Such information may include work orders generated at the central facility or other information that may be stored or generated at the central facility that may be useful to the field worker, and may in certain instances include bi-directional communications.

While the presently disclosed subject matter has been described in detail with respect to specific embodiments thereof, it will be appreciated that those skilled in the art, upon attaining an understanding of the foregoing, may readily produce alterations to, variations of, and equivalents to such embodiments. Accordingly, the scope of the present disclosure is by way of example rather than by way of limitation, and the subject disclosure does not preclude inclusion of such modifications, variations, and/or additions to the presently disclosed subject matter as would be readily apparent to one of ordinary skill in the art.

What is claimed is:

1. A network, comprising:
a cell relay;
a central facility including a management system; and
a local area network coupling said cell relay and said central facility,
wherein said cell relay includes WiFi functionality configured to provide communications with at least said central facility.

2. A network as in claim 1, further comprising:
a WiFi enabled communications device,
wherein operation of said communications device enables a utility worker to receive information from said central facility.

3. A network as in claim 2, wherein said communications device enables a utility worker to receive and respond to work order information from said central facility

4. A network as in claim 2, further comprising:
interconnection between said local area network and a wide area network,
whereby communications over said wide area network are enabled through said WiFi enabled device.

5. A network as in claim 4, wherein said wide area network is the Internet.

6. A network as in claim 1, further comprising:
a firewall coupled between said cell relay and said local area network.

7. A network as in claim 2, wherein said WiFi enabled communications device comprises one of a laptop computer, a netbook computer, a tablet computer, a personal digital assistant (PDA), a cell phone, a smart phone, a desktop computer, and a dedicated wireless communication device.

8. A network as in claim 1, wherein said cell relay is configured to provide bi-directional WiFi communications functionality.

9. A network as in claim 1, further comprising:
at least one utility consumption measuring meter configured to measure consumption and store consumption related data; and
a collection engine associated with said central facility,
wherein said at least one utility consumption measuring meter is configured to send its stored consumption related data to said collection engine by way of said cell relay.

10. A network as in claim 1, further comprising:
a WiFi enabled bi-directional communications device;
at least one utility consumption measuring meter configured to measure consumption and store consumption related data;
a collection engine associated with said central facility; and
interconnection between said local area network and a wide area network, whereby communications over said wide area network are enabled through said WiFi enabled device;
wherein said at least one utility consumption measuring meter is configured to send its stored consumption related data to said collection engine by way of said cell relay; and
operation of said communications device enables a utility worker to receive and respond to work order information from said central facility via said cell relay.

11. A cell relay, comprising:
a first communications channel for communicating utility consumption related data to a central facility; and
a WiFi enabled communications channel for communicating information from a central facility to field worker proximate said cell relay.

12. A cell relay as in claim 11, wherein said WiFi enabled communications channel employs an Internet Protocol (IP) communications standard.

13. A cell relay as in claim 11, wherein said WiFi enabled communications channel is configured to enable bi-directional communications between said cell relay and a central facility.

14. A method for providing communications capabilities between a network central facility and a remote field worker, comprising:
establishing a network including network components corresponding to a central facility, a cell relay and at least one consumption measuring device:
establishing a first communications channel to provide communications among the network components;
establishing a second, wireless communications channel for the cell relay; and
configuring the second communications channel to provide communications between the central facility and a worker proximate the cell relay.

15. A method as in claim 14, wherein establishing a second communications channel comprises establishing a WiFi communications channel.

16. A method as in claim 14, wherein configuring the second communications channel comprises:
configuring the wireless channel to provide communications between the cell relay and a worker proximate the cell relay; and
configuring the first communications channel to carry information from the second communications channel between the cell relay and the central facility.

17. A method as in claim 14, wherein the central facility includes work order generating functionality and the second communications channel transmits work order information to a worker proximate the cell relay.
